(19) United States
(12) Patent Application Publication
(10) Pub. No.: US 2016/0049039 A1
(43) Pub. Date: Feb. 18, 2016

(54) Electronic Skill Game

(71) Applicant: Banilla Games, Inc., Greenville, NC (US)

(72) Inventors: Garrett Blackwelder, Grimesland, NC (US); Kevin Morse, Greenville, NC (US); Timothy Smith, Grimesland, NC (US); Justin Harris, Greenville, NC (US)

(73) Assignee: Banilla Games, Inc., Greenville, NC (US)

(21) Appl. No.: 14/825,908

(22) Filed: Aug. 13, 2015

Related U.S. Application Data
(60) Provisional application No. 62/037,263, filed on Aug. 14, 2014.

(51) Int. Cl. G07F 17/32

(52) U.S. Cl. CPC G07F 17/3213; G07F 17/3209

(57) ABSTRACT

An electronic skill game system and method are provided. The electronic skill game system may include an electronic skill game; a display; one or more user inputs; and one or more computer processors associated with the electronic skill game, display, and the one or more user inputs. The one or more computer processors are preferably programmed to perform operations including generating an electronic skill game board screen on the display including at least one pattern of icons and a set of alternate icons displayed on the electronic skill game board screen; receiving and processing one or more user inputs, wherein the one or more user inputs comprise a user selecting one of the alternate icons to replace a designated icon of the pattern of icons; and outputting an outcome based on the user's selection.

### CROSS REFERENCE TO RELATED APPLICATIONS

This application claims priority and is related to U.S. Provisional Application No. 62/037,263, filed Aug. 14, 2014, the entire disclosure of which is incorporated herein by reference.

### TECHNICAL FIELD

The invention is directed to an electronic skill game. Specifically, the invention is related to an electronic skill-based redemption game.

### BACKGROUND

Electronic skills games, such as electronic skill-based redemption games (a.k.a. nudge games), are widely used in various jurisdictions, such as Georgia, that allow gaming devices that are based on a players use of some “skill” to potentially win something of value. However, most of these electronic skills games lack the look and feel of traditional gaming systems, such as slot machines. This negatively affects a player's experience and, thus, the attractiveness of playing such games.

Therefore, there is a need for an improved electronic skill game that has the look and feel of traditional gaming systems, such as slot machines, and the like, but that requires some level of player “skill” to play the game and potentially win something of value.

### SUMMARY

In one embodiment, an electronic skill game system is provided. The electronic skill game system may include an electronic skill game; a display; one or more user inputs; and one or more computer processors associated with the electronic skill game, display, and the one or more user inputs. The one or more computer processors are preferably programmed to perform operations including generating an electronic skill game board screen on the display including at least one pattern of icons and a set of alternate icons displayed on the electronic skill game board screen; receiving and processing one or more user inputs, wherein the one or more user inputs comprise a user selecting one of the alternate icons to replace a designated icon of the pattern of icons; and outputting an outcome based on the user's selection. The display and the one or more user inputs may be components of one or more electronic game devices. The one or more computer processors may be a component of the one or more electronic game devices. The one or more computer processors may be remote from the one or more electronic game devices. The electronic skill game system may further include a database associated with the one or more computer processors. The database may include an outcome repository including a predefined finite list of the pattern of icons and/or alternate icons to be displayed on the electronic skill game board screen for one or more upcoming game plays of the electronic skill game. The one or more computer processors may be programmed to further perform operations including displaying all of or a portion of the predefined finite list of the pattern of icons and/or alternate icons. The one or more computer processors may be programmed to further perform operations including at least one of randomly or pseudo-randomly generate the at least one pattern of icons and/or the set of alternate icons for display on the electronic skill game board screen. The outcome may include one of a win or a loss designation. The win outcome may include the user selecting one of the alternate icons to replace the designated icon that correctly completes the at least one pattern of icons in accordance with predefined criteria. An associated prize may be awarded upon a win outcome. The associated prize may include any one of money, merchandise, tokens, points, credits, chips, tallies, tickets, and/or an item of value or perceived value. The at least one pattern of icons and set of alternate icons may be displayed on separate portions of the electronic skill game board screen. The electronic skill game board screen may include a multi-reel slot machine style game. The electronic skill game may include one or more levels of play. The electronic skill game system may further include one or more pay lines designated on the electronic skill game board screen. The at least one pattern of icons may be defined along one or more of the one or more pay lines. A plurality of electronic skill games may be networked together.

In another embodiment, a method of playing an electronic skill game is provided. The method of playing the electronic skill game may include accessing an electronic skill game, which may include a display and one or more user inputs; activating the electronic skill game, wherein upon activating the electronic skill game an electronic skill game board screen is displayed, which may at least one pattern of icons and a set of alternate icons; and selecting one of the alternate icons to replace a designated icon of the at least one pattern of icons, wherein upon making a correct selection an associated prize is awarded. The method may further include providing consideration prior to a game play. The consideration may include any one or more of money, tokens, points, chips, tallies, tickets, codes, and/or the like. The method may further include selecting a play amount for a particular game play. The play amount may include a value of any one or more of money, tokens, points, chips, tallies, tickets, and/or the like selected to play a particular game play. Activating the particular game of the electronic skill game may include a user selecting a corresponding user input. The at least one pattern of icons and the set of alternate icons may be displayed on separate portions of the electronic skill game board screen. The at least one pattern of icons and/or the set of alternate icons may be one or more of randomly generated, pseudo-randomly generated, and/or selected from a predefined finite list of patterns of icons and/or alternate icons. Selecting one of the alternate icons may include a user selecting one or more corresponding user inputs to cause one of the alternate icons to replace the designated icon of the at least one pattern of icons. Upon making an incorrect selection a play amount selected by a user for a particular game play may be deducted from an amount of consideration that was provided by the user prior to the game play. The electronic skill game board screen may include a multi-reel slot machine style game. The electronic skill game may include one or more levels of play. The electronic skill game may include one or more pay lines designated on the electronic skill game board screen. The at least one pattern of icons may be defined along one or more of the one or more pay lines. The method may further include viewing a predefined finite list of the at least one pattern of icons and/or set alternate icons of one or more upcoming game plays on the electronic skill game screen prior to a game play. Making the correct selection may include selecting one of the alternate icons to replace the designated icon that correctly completes the at least one pattern of icons in accordance with predefined criteria. If more than one selection is available to replace the designated icon of the at least one pattern of icons, the correct selection may include selecting an alternate icon that most correctly completes the at least one pattern of icons in accordance with predefined criteria. The at least one pattern of icons and/or pay line associated with the at least one pattern of icons may include a value associated therewith, and selecting the alternate icon that most correctly completes the at least one pattern of icons may include selecting an alternate icon that provides the at least one pattern of icons resulting in a highest value as compared to the other available selections.

### BRIEF DESCRIPTION OF THE DRAWINGS

Having thus described the presently disclosed subject matter in general terms, reference will now be made to the accompanying Drawings, which are not necessarily drawn to scale, and wherein:

FIGS. 1A-B illustrate a view of example electronic game board screens of an electronic skill game in accordance with an embodiment of the invention;

FIGS. 2A-B illustrate a view of example electronic game rules screen of the electronic skill game in accordance with an embodiment of the invention; and

FIG. 3 illustrates a high-level view of a plurality of electronic game devices networked together in accordance with an embodiment of the invention.

### DETAILED DESCRIPTION

The presently disclosed subject matter now will be described more fully hereinafter with reference to the accompanying Drawings, in which some, but not all embodiments of the presently disclosed subject matter are shown. Like numbers refer to like elements throughout. The presently disclosed subject matter may be embodied in many different forms and should not be construed as limited to the embodiments set forth herein; rather, these embodiments are provided so that this disclosure will satisfy applicable legal requirements. Indeed, many modifications and other embodiments of the presently disclosed subject matter set forth herein will come to mind to one skilled in the art to which the presently disclosed subject matter pertains having the benefit of the teachings presented in the foregoing descriptions and the associated Drawings. Therefore, it is to be understood that the presently disclosed subject matter is not to be limited to the specific embodiments disclosed and that modifications and other embodiments are intended to be included within the scope of the appended claims.

The invention provides an electronic skill game, system, and method in which a player must use some level of skill to make a correct selection or action to win, for example, the user may be required to choose a correct one of a plurality of icons displayed on an electronic game board display to complete a winning pay line displayed on the electronic game board screen and win a prize, which may take a number of forms, including, but not limited to money, merchandise, tokens, points, credits, chips, tallies, tickets, or other item of value or perceived value.

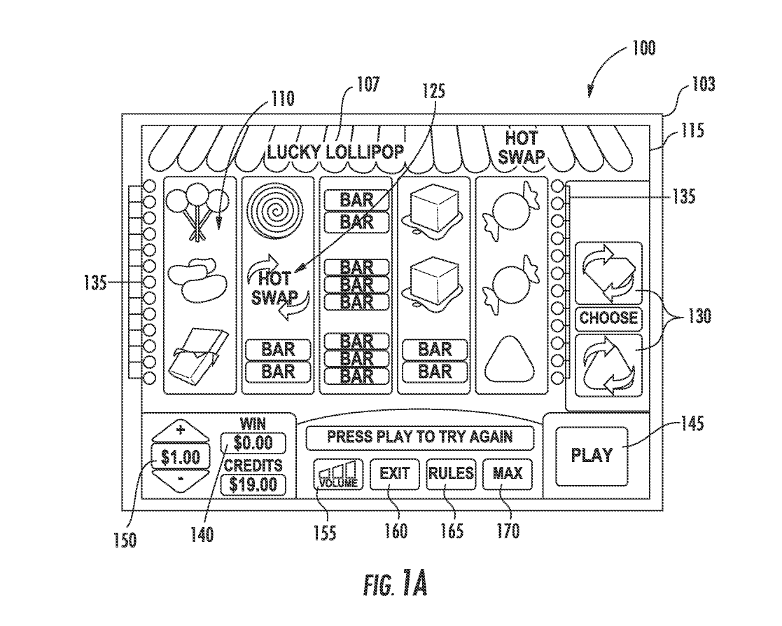

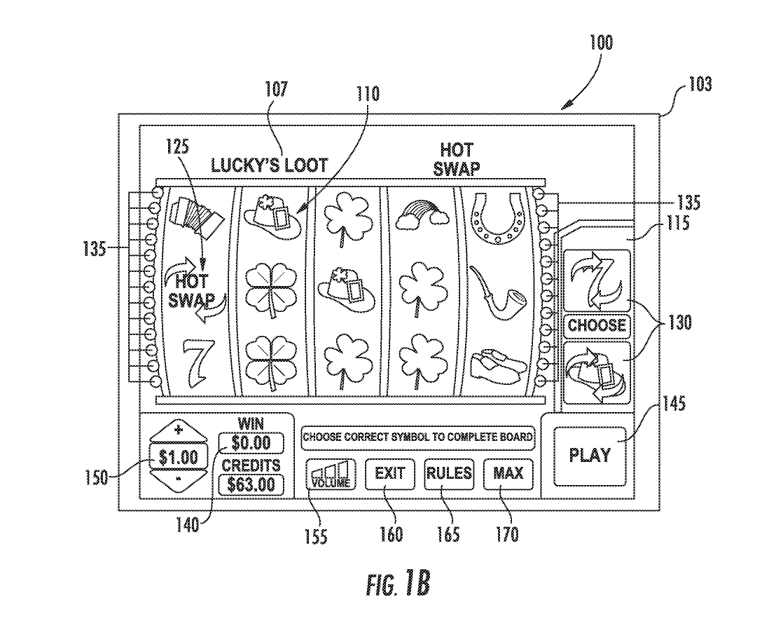

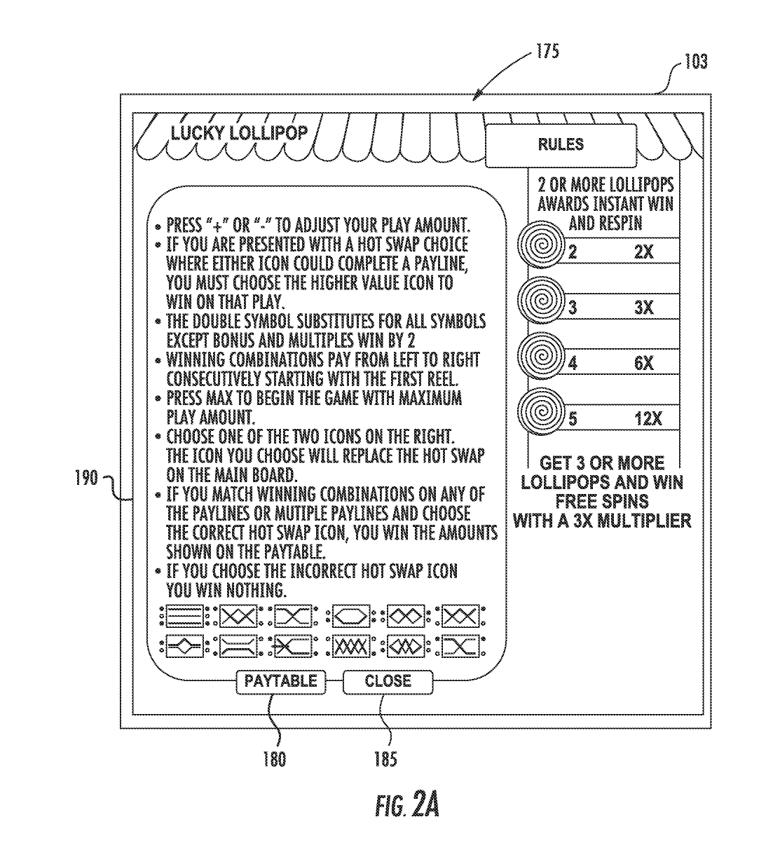

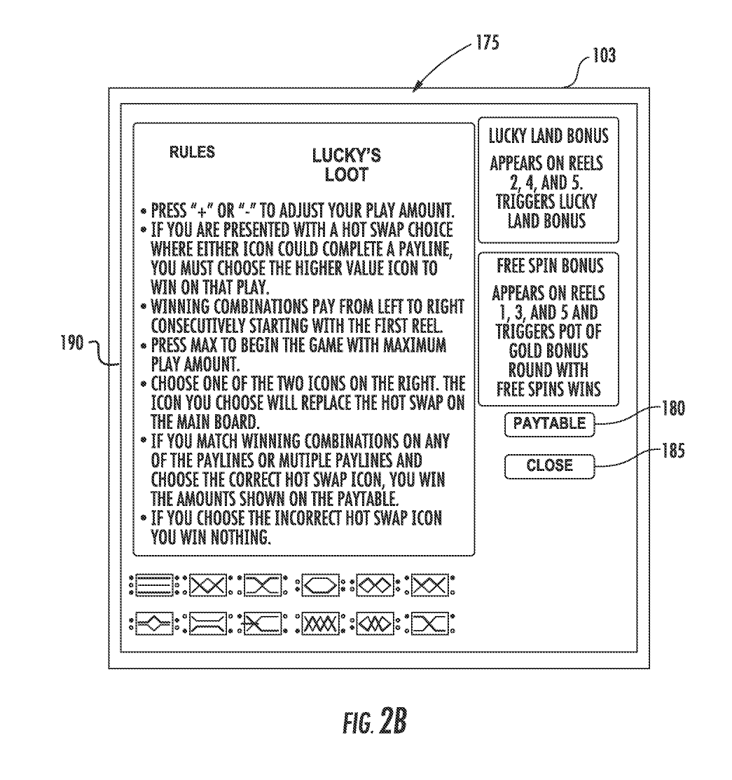

Referring to the drawings, FIGS. 1-3 illustrate an electronic game system 100. In one embodiment, a player accesses an electronic game device 103 and initiates/activates an electronic skill game 107. Upon initiation/activation of electronic skill game 107 the player is presented with a pattern of icons 110 displayed on electronic game board screen 115 of electronic game device 103, and the player has the opportunity to replace, e.g., “swap”, an icon, such as designated icon 125 (e.g., “Hot Swap” icon), in the displayed pattern of icons 110 with one of a plurality of alternate icons 130, displayed separately from the pattern of icons 110, and therefore the player may “swap” icon 125 in the displayed pattern for one of alternate icons 130. If the player selects a correct alternate icon 130 to swap with designated icon 125, e.g., an icon that correctly completes one or more pay lines 135 based on some predefined criteria (e.g., completes a predefined winning pattern of icons on one or more pay lines 135) on the game display 115, then the player wins an associated prize 140. However, if the player selects an incorrect alternate icon 130, e.g., an icon that does not correctly (or most correctly), complete one or more pay lines 135 on electronic game board screen 115, then the player does not win the associated prize 140. Game 107 may have one or more pay lines 135 that correspond to various patterns of icons 110 displayed on game display 107. In a non-limiting example, pay lines 135 may include one or more lines that pass through a plurality of icons 135. For example, in a five reel slot machine style game as shown, for example, in FIGS. 2A-B, pay lines 135 may include one or more straight and/or zig-zag lines passing through a series of five icons in a generally horizontal direction across the five reels. Pay lines 135 may have a value, such as a number value, associate therewith, and the criteria to win requires a user to select the alternate icon to replace the designated icon that completes a pattern of icons 110 along one of pay lines 135 that yields the highest value.

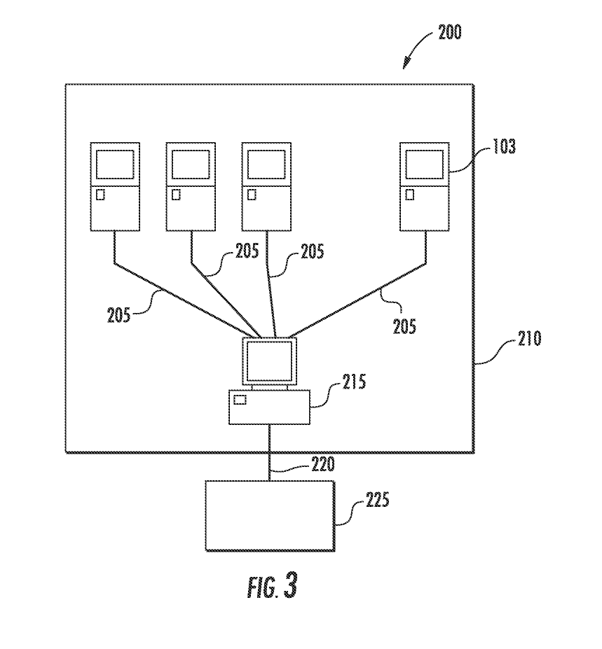

Game system 100 may include one or more game devices 103. Game devices 103 may be any device capable of allowing a player to play a game, or games, and may also be capable of dispensing prizes/awards, monetary or otherwise, as appropriate. Game device 103 may be a stand-alone unit capable of operating play on its own or, may be part of a network 200 (as shown in FIG. 3) that has a plurality of networked game devices 103. Game device 103 may be configured to display an electronic skill game 107, e.g., an electronic skill-based redemption game. Game system 100 may further be configured with a finite, predefined pool of outcomes (e.g., displayed image patterns, designated images, and/or alternate images) and/or prizes 140 for each play, and/or at each level for multi-level games. Alternatively, outcomes and/or prizes 140 may be generated randomly, pseudo randomly, or combination of any of the above. In one embodiment, a user may be able to view the outcome (e.g., for each game play, whether from a finite predefined pool of outcomes, or generated randomly or pseudo randomly) prior to playing the game and/or prior to providing consideration for playing the game.

In one embodiment of the invention, electronic skill game 107 may be, for example, in the form of a five reel slot machine style game as shown, for example, in FIGS. 1A-B. However, the invention is not limited to only slot machine style games. Various embodiments of the invention can be used to illustrate view play of any game capable of being played on an electronic gaming machine. For example, the game device 103 may be configured to play games, including, but not limited to, slots, video poker, keno, black jack, and/or other gaming style electronic games.

Game system 100 preferably includes a number of buttons and/or other similar activation and/or selection type mechanisms for user input (such as a player and/or operator). Such, buttons, activation, or selection mechanism may take the form of any of buttons, switches, dials, touch screen, touch pad/surface, mouse, voice/sound prompts, or other suitable mechanism, whether currently known or in the future, and any combination thereof that permits a user to activate or make a selection or action for the purpose of playing or operating game system 100, (generically referred to as “buttons” hereinafter). Examples of such buttons associated with game system 100 may include, but are not limited to, play 145, play amount 150, volume 155, exit 160, rules 165, max play amount 170, and/or any other suitable buttons for a player or operator to play or operate game system 100.

With reference to FIGS. 2A-B, by a player/operator selecting rules 165, game system 100 may display a game rules screen 175 on, for example, electronic game device 103. Rules display 175 may include a plurality of other selectable buttons, including but not limited to, pay table 180, close 185, and/or any other suitable buttons for a player or operator to play or operate game system 100. In one non-limiting example, by selecting pay table 180, a player or operator of game system 100 may be able to view all or a portion of the outcomes, or prizes 140 for a particular game 107, e.g., a finite preselected list of outcomes and/or prizes 140 for each play, and/or at each level of play for multi-level games. By selecting close 185, a player or operator of game system 100 may exit game rules screen 175 and return to a home screen or previous game play screen of electronic skill game 107. Game rules screen 175 may include one or more of a set of rules 190 for playing a particular electronic skill game 107, winning pay lines 135, and/or other information related to play or operation of the particular electronic skill game 107. Game device 103 may include a display for displaying electronic game board screen 115 for electronic skill game 107, and may include a number of pay lines 135, (e.g., shown as numbered 1-25 in FIGS. 1A and 1B), wherein on a given play if a winning pattern of icons 110 is displayed on, or caused to be displayed by a user's selection, on one or more of pay lines 135 (e.g., matching winning combinations on one or more pay lines 135), the player will win associated prize 140.

In one example, a player inserts some amount consideration into game device 103, or otherwise provides the consideration to play an electronic skill game 107.

Consideration may take a number of forms, including, but not limited to money, tokens, points, chips, tallies, tickets, activation code, or the like, whether purchased, earned, or otherwise received in order to use, activate, or play electronic skill game 107. The player may then decide what play amount 150 the player wants to play (i.e., the amount of the inserted consideration for a particular game play), by making the appropriate selection of the play amount 150 button to increase or decrease the amount. Once the play amount 150 is selected the player may then select play button 145 to start/activate a game play. In one non-limiting example, upon selecting play button 145 game system 100 causes a pattern of icons 110 to be generated and displayed, for example, represented across a series of reels on electronic game board screen 115. Game system 100 further causes a number of alternate icons 130 to also be displayed on a separate area of electronic game board screen 115 from that of the pattern of icons 110, for example on a side portion of electronic game board screen 115. The generated pattern of icons 110 and/or alternate icons 130 may be randomly or pseudo-randomly generated by game system 100, or may be from a finite predefined pool/list. The player then selects, using one or more user inputs, one of the alternate icons 130 to replace (swap with) a designated icon 125 (e.g., “Hot Swap” icon) in the pattern of icons 110 displayed on electronic game board screen 115. If the player selects an alternate icon 130 that correctly completes one or more pay lines 135 on electronic game board screen 115, then the player wins associated prize 140. However, if the player selects an incorrect alternate icon 130, e.g., an icon that does not correctly complete a pay line 135 on the electronic game board screen 115, then the player does not win associated prize 140, and the selected play amount 150 that the player selected is deducted from the amount of consideration the player inserted into, or provided to play, electronic skill game 107.

In another example, if the player is presented with a designated icon 125 (e.g., “Hot Swap” icon), and more than one of the alternate icons 130 could complete one of the pay lines 135, or one of the alternate icons 130 could complete more than one of the pay lines 135, the player must select an alternate icon 130 that would best complete the pay line 135, i.e., the alternate icon 130 that would give pay line 135 the highest value, in order to win the associated prize 140. If the player selects an alternate icon 130 that completes a lower value pay line 135, then the player does not win the associated prize 140, and the amount of the player selected pay amount 150 is deducted from the amount of consideration provided by the player.

In yet another embodiment, if a game play yields a pattern of icons 110, wherein selecting one of alternate icons 130 would correctly complete a pay line 135, i.e., a winning combination is possible, electronic skill game 107 will not allow the player to play again until the player selects one of the alternate icons 130 to swap with the designated icon 125, regardless of whether or not it is the correct swap.

The term select, selection, activate, activation, access, accessing, and the like, shall mean any suitable method/mechanism for making a selection, activation, and/or accessing, including but not limited to, using a button, switch, dial, knob, touch screen, touch pad/surface, voice/sound prompt, mouse click, joy stick, or the like, whether currently known or in the future, and any combination thereof.

Game system 100 may also include a software component. The software component may be part of, or added to an existing software program of the game device 103. The software component may be programmed or otherwise embedded into a readable storage medium and may be on a printed circuit board, or the like, which may then be connected to game devices 103, e.g., to existing display monitor, control buttons, and any other necessary game components. Alternatively, the existing software program and/or the software component may be loaded on remote system manager computer 215 and/or a remote centralized data center computer 225 Shown in FIG. 3).

The software component may include one or more of the following executable instructions to be carried out by the software: generation of an on screen display that may include a game title, a set of instructions, game graphics, and/or an outcome table, list and/or display; receive input of a player's or operator's commands through anyone of a plurality of inputs to any of game system's 100 hardware; accessing a database of predetermined graphics, symbols, tables and/or values, to create the game displays; accessing an outcome/prize table, which may be saved in a game memory storage medium, having a finite preselected list of outcomes and/or prizes for each level of game play, or accessing a random or pseudo random outcome and/or prize generator for generating the outcomes and/or prizes for each level of game play. The software component may further include executable instructions to be carried out by the software, such as, initiating the game upon selection of the selected game play, and tracking and recording game play data and accounting such as number of plays, credits in/out (consideration taken in/payouts), and the like.

With reference to FIG. 3, a network 200 for providing a networked electronic game system 100 according to one embodiment of the present invention is illustrated. Network 200 may include one or more game devices 103, networked together via a communication link 205 at a particular location, for example, a single site indicated by box 210, or across multiple locations, e.g., multiple sites 210. In addition, each game device 103 may be networked via communication link 205 to one or more system manager computers 215. The system manager computer 215 may be located at site 210, or alternatively may be remote from site 210. System manager computer 215 may be networked via a communication link 220 to one or more remote data center computers 225.

It will be appreciated that data communication between components of network 200 may be adapted to send and receive data via wired, wireless transmissions, using any suitable wireless connection, or a combination of wired and wireless transmissions.

Communication links 205 and 220 may comprise modems, telephone lines, the Internet, intranet, satellites, wireless connections, or the like, whether currently known or in the future, and any combination thereof for sending and receiving data and signals. Communication links 205 and 220 preferably provide a fast, efficient, reliable, and secure means for transferring digital data between components of network 200.

System manager computer 215, in one embodiment, preferably provides a hub for game devices 103 and performs various other site-related functions. For example, system manager computer 215, may maintain and provide accounting information for site 210, contain information related to game system 100, and/or transmit game information (updates, new games, fixes, and the like) to the game devices 103.

In an embodiment, selected data may be periodically transferred back and forth between system manager computer 215 and data center computer 225. For example, type and amount of accumulated transactions may be reported by each system manager computer 215 to data center computer 225 on a regular basis, such as hourly, daily, weekly, etc. Game devices 103 may communicate directly with system manager computer 215 and/or data center computer 225.

Data center computer 225 may store, track, and maintain game outcome tables for all games currently being played. In one embodiment data center computer 225, or alternatively system manager computer 215, may also store all game software, information, and instruction, and game devices 103 may function primarily as a means of accepting the game information and instruction, displaying the game to the player for play, for example, although the player enters a game selections and plays the game from game devices 103, the actual functionality of the game may be performed remotely by data center computer 225, or alternatively system manager computer 215.

It will be appreciated that in alternate embodiments the functions and operations of system manager computer 215 and data center computer 225 may be combined in different configurations into one or more computers or stations located either at site 210 or remote from site 210. System manager computer 215 and data center computer 225 may be any standard computer for example, be a general purpose computer, special purpose computer, personal computer, or other programmable data processing apparatus. System manager computer 215 and data center computer 225 may comprise a memory, and may serve to provide processing capabilities, such as storing, interpreting, and/or executing software instructions, as well as controlling the overall operation of the system. System manager computer 215 and data center computer 225 may be configured and programmed to control data, communications, and/or power aspects of these devices.

It will be appreciated that various aspects of the invention may be embodied as a method, system, computer readable medium, and/or computer program product. Aspects of the invention may take the form of hardware embodiments, software embodiments (including firmware, resident software, micro-code, etc.), or embodiments combining software and hardware aspects that may all generally be referred to herein as a “circuit,” “module” or “system.” Furthermore, the methods of the invention may take the form of a computer program product on a computer-usable storage medium having computer-usable program code embodied in the medium.

Any suitable computer useable medium may be utilized for software aspects of the invention. The computer-usable or computer-readable medium may be, for example but not limited to, an electronic, magnetic, optical, electromagnetic, infrared, or semiconductor system, apparatus, device, or propagation medium. The computer readable medium may include transitory and/or non-transitory embodiments. More specific examples (a non-exhaustive list) of the computer-readable medium would include some or all of the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission medium such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. Program code for carrying out operations of the invention may be written in an object oriented programming language such as Java, Smalltalk, C++ or the like. However, the program code for carrying out operations of the invention may also be written in conventional procedural programming languages, such as the “C” programming language or similar programming languages. The program code may be executed by a processor, application specific integrated circuit (ASIC), or other component that executes the program code. The program code may be simply referred to as a software application that is stored in memory (such as the computer readable medium discussed above). The program code may cause the processor (or any processor-controlled device) to produce a graphical user interface (“GUI”). The graphical user interface may be visually produced on a display device, yet the graphical user interface may also have audible features. The program code, however, may operate in any processor-controlled device, such as a computer, server, personal digital assistant, phone, television, or any processor-controlled device utilizing the processor and/or a digital signal processor.

The program code may locally and/or remotely execute. The program code, for example, may be entirely or partially stored in local memory of the processor-controlled device. The program code, however, may also be at least partially remotely stored, accessed, and downloaded to the processor-controlled device. A user's computer, for example, may entirely execute the program code or only partly execute the program code. The program code may be a stand-alone software package that is at least partly on the user's computer and/or partly executed on a remote computer or entirely on a remote computer or server. In the latter scenario, the remote computer may be connected to the user's computer through a communications network.

The invention may be applied regardless of networking environment. The communications network may be a cable network operating in the radio-frequency domain and/or the Internet Protocol (IP) domain. The communications network, however, may also include a distributed computing network, such as the Internet (sometimes alternatively known as the “World Wide Web”), an intranet, a local-area network (LAN), and/or a wide-area network (WAN). The communications network may include coaxial cables, copper wires, fiber optic lines, and/or hybrid-coaxial lines. The communications network may even include wireless portions utilizing any portion of the electromagnetic spectrum and any signaling standard (such as the IEEE 802 family of standards, GSM/CDMA/TDMA or any cellular standard, and/or the ISM band). The communications network may even include powerline portions, in which signals are communicated via electrical wiring. The invention may be applied to any wireless/wireline communications network, regardless of physical componentry, physical configuration, or communications standard(s).

Certain aspects of invention are described with reference to various methods and method steps. It will be understood that each method step may be implemented by the program code and/or by machine instructions. The program code and/or the machine instructions may create means for implementing the functions/acts specified in the methods.

The program code may also be stored in a computer-readable memory that can direct the processor, computer, or other programmable data processing apparatus to function in a particular manner, such that the program code stored in the computer-readable memory produce or transform an article of manufacture including instruction means which implement various aspects of the method steps.

The program code may also be loaded onto a computer or other programmable data processing apparatus to cause a series of operational steps to be performed to produce a processor/computer implemented process such that the program code provides steps for implementing various functions/acts specified in the methods of the invention.

Following long-standing patent law convention, the terms “a,” “an,” and “the” refer to “one or more” when used in this application. Thus, for example, reference to “a subject” includes a plurality of subjects, unless the context clearly is to the contrary (e.g., a plurality of subjects), and so forth.

Throughout this specification, the terms “comprise,” “comprises,” and “comprising” are used in a non-exclusive sense, except where the context requires otherwise. Likewise, the term “include” and its grammatical variants are intended to be non-limiting, such that recitation of items in a list is not to the exclusion of other like items that can be substituted or added to the listed items.

For the purposes of this specification, unless otherwise indicated, all numbers expressing amounts, sizes, dimensions, proportions, shapes, formulations, parameters, percentages, parameters, quantities, characteristics, and other numerical values used in the specification and claims, are to be understood as being modified in all instances by the term “about” even though the term “about” may not expressly appear with the value, amount or range. Accordingly, unless indicated to the contrary, the numerical parameters set forth in the following specification and attached claims are not and need not be exact, but may be approximate and/or larger or smaller as desired, reflecting tolerances, conversion factors, rounding off, measurement error and the like, and other factors known to those of skill in the art depending on the desired properties sought to be obtained by the presently disclosed subject matter. For example, the term “about,” when referring to a value can be meant to encompass variations of, in some embodiments,±100% in some embodiments±50%, in some embodiments±20%, in some embodiments ±10%, in some embodiments±5%, in some embodiments±1%, in some embodiments±0.5%, and in some embodiments±0.1% from the specified amount, as such variations are appropriate to perform the disclosed methods or employ the disclosed compositions.

Further, the term “about” when used in connection with one or more numbers or numerical ranges, should be understood to refer to all such numbers, including all numbers in a range and modifies that range by extending the boundaries above and below the numerical values set forth. The recitation of numerical ranges by endpoints includes all numbers, e.g., whole integers, including fractions thereof, subsumed within that range (for example, the recitation of 1 to 5 includes 1, 2, 3, 4, and 5, as well as fractions thereof, e.g., 1.5, 2.25, 3.75, 4.1, and the like) and any range within that range.

Although the foregoing subject matter has been described in some detail by way of illustration and example for purposes of clarity of understanding, it will be understood by those skilled in the art that certain changes and modifications can be practiced within the scope of the description herein.

What is claimed is:

1. An electronic skill game system, comprising:
a. an electronic skill game;
b. a display;
c. one or more user inputs; and
d. one or more computer processors associated with the electronic skill game, display, and the one or more user inputs, the one or more computer processors programmed to perform operations including:
i. generating an electronic skill game board screen on the display including at least one pattern of icons and a set of alternate icons displayed on the electronic skill game board screen;
ii. receiving one or more user inputs, wherein the one or more user inputs comprise a user selecting one of the alternate icons to replace a designated icon of the pattern of icons; and
iii. outputting an outcome based on the user's selection.

2. The electronic skill game system of claim 1 wherein the display and the one or more user inputs are components of one or more electronic game devices.

3. The electronic skill game system of claim 2 wherein the one or more computer processors are a component of the one or more electronic game devices.

4. The electronic skill game system of claim 2 wherein the one or more computer processors are remote from the one or more electronic game devices.

5. The electronic skill game system of claim 1 further comprising a database associated with the one or more computer processors.

6. The electronic skill game system of claim 5 wherein the database comprises an outcome repository comprising a predefined finite list of the pattern of icons and/or alternate icons to be displayed on the electronic skill game board screen for one or more upcoming game plays of the electronic skill game.

7. The electronic skill game system of claim 6 wherein the one or more computer processors are programmed to further perform operations including displaying all of or a portion of the predefined finite list of the pattern of icons and/or alternate icons.

8. The electronic skill game system of claim 1 wherein the one or more computer processors are programmed to further perform operations including at least one of randomly or pseudo-randomly generate the at least one pattern of icons and/or the set of alternate icons for display on the electronic skill game board screen.

9. The electronic skill game system of claim 1 wherein the outcome comprises one of a win or a loss designation.

10. The electronic skill game system of claim 9 wherein a win outcome comprises the user selecting one of the alternate icons to replace the designated icon that correctly completes the at least one pattern of icons in accordance with predefined criteria.

11. The electronic skill game system of claim 9 wherein an associated prize is awarded upon a win outcome.

12. The electronic skill game system of claim 11 wherein the associated prize comprises any one of money, merchandise, tokens, points, credits, chips, tallies, tickets, and/or an item of value or perceived value.

13. The electronic skill game system of claim 1 wherein the at least one pattern of icons and set of alternate icons are displayed on separate portions of the electronic skill game board screen.

14. The electronic skill game system of claim 1 wherein the electronic skill game board screen comprises a multi-reel slot machine style game.

15. The electronic skill game system of claim 1, wherein the electronic skill game comprises one or more levels of play.

16. The electronic skill game system of claim 1, further comprising one or more pay lines designated on the electronic skill game board screen.

17. The electronic skill game system of claim 16, wherein the at least one pattern of icons is defined along one or more of the one or more pay lines.

18. The electronic skill game system of claim 1, wherein a plurality of electronic skill games are networked together.

19. A method of playing an electronic skill game, the method comprising:
a. accessing an electronic skill game comprising a display and one or more user inputs;
b. activating the electronic skill game, wherein upon activating the electronic skill game an electronic skill game board screen is displayed comprising at least one pattern of icons and a set of alternate icons; and
c. selecting one of the alternate icons to replace a designated icon of the at least one pattern of icons, wherein upon making a correct selection an associated prize is awarded.

20. The method of claim 19 further comprising providing consideration prior to a game play.

21. The method of claim 20 wherein the consideration comprises any one or more of money, tokens, points, chips, tallies, tickets, and/or codes.

22. The method of claim 19 further comprising selecting a play amount for a particular game play.

23. The method of claim 22 wherein the play amount comprises a value of any one or more of money, tokens, points, chips, tallies, and/or tickets selected to play a particular game play.

24. The method of claim 19 wherein activating the particular game of the electronic skill game comprises a user selecting a corresponding user input.

25. The method of claim 19 wherein the at least one pattern of icons and the set of alternate icons are displayed on separate portions of the electronic skill game board screen.

26. The method of claim 19 wherein the at least one pattern of icons and/or the set of alternate icons are one or more of randomly generated, pseudo-randomly generated, and/or selected from a predefined finite list of patterns of icons and/or alternate icons.

27. The method of claim 19 wherein selecting one of the alternate icons comprises a user selecting one or more corresponding user inputs to cause one of the alternate icons to replace the designated icon of the at least one pattern of icons.

28. The method of claim 19 wherein upon making an incorrect selection a play amount selected by a user for a particular game play is deducted from an amount of consideration that was provided by the user prior to the game play.

29. The method of claim 19 wherein the electronic skill game board screen comprises a multi-reel slot machine style game.

30. The method of claim 19 wherein the electronic skill game comprises one or more levels of play.

31. The method of claim 19 wherein the electronic skill game comprises one or more pay lines designated on the electronic skill game board screen.

32. The electronic game of claim 31 wherein the at least one pattern of icons is defined along one or more of the one or more pay lines.

33. The method of claim 19 further comprising viewing a predefined finite list of the at least one pattern of icons and/or set alternate icons of one or more upcoming game plays on the electronic skill game screen prior to a game play.

34. The method of claim 19 wherein making the correct selection comprises selecting one of the alternate icons to replace the designated icon that correctly completes the at least one pattern of icons in accordance with predefined criteria.

35. The method of claim 19 wherein if more than one selection is available to replace the designated icon of the at least one pattern of icons, the correct selection comprises selecting an alternate icon that most correctly completes the at least one pattern of icons in accordance with predefined criteria.

36. The method of claim 35 wherein the at least one pattern of icons and/or pay line associated with the at least one pattern of icons comprises a value associated therewith, and selecting the alternate icon that most correctly completes the at least one pattern of icons comprises selecting an alternate icon that provides the at least one pattern of icons resulting in a highest value as compared to the other available selections.

37. The method of claim 19, wherein if a correct selection is possible, a user cannot play another game play until the user selects one of the alternate icons to replace the designated icon of the at least one pattern of icons.
